(19) United States
(12) Patent Application Publication
(10) Pub. No.: US 2025/0019232 A1
(43) Pub. Date: Jan. 16, 2025

(54) HYDROGEN GENERATOR

(71) Applicant: Jose Antonio GONZÁLEZ IBAÑEZ, Madrid (ES)

(72) Inventor: Jose Antonio GONZÁLEZ IBAÑEZ, Madrid (ES)

(21) Appl. No.: 18/717,601

(22) PCT Filed: Dec. 28, 2022
(86) PCT No.: PCT/ES2022/070840

§ 371 Date: Jun. 7, 2024

(30) Foreign Application Priority Data
Jan. 7, 2022 (ES) U202230023

(51) Int. Cl. C01B 3/08

(52) U.S. Cl. CPC C01B 3/08; C01B 2203/1205; C01B 2203/1628

(57) ABSTRACT

Disclosed is an installation having a pressurised tank acting as a reactor, into which water, ferrosilicon, sodium hydroxide and pressurised air are introduced, the latter by a compressor and a pipe assisted by a solenoid valve and/or shut-off valve, provided with a non-return valve and a flow/pressure regulator. The reactor includes an upper outlet which is connected to a pipe in which a second non-return valve is installed, and which feeds a pressurised wash tank. The upper part includes a pipe with a third non-return valve which feeds a pressurised hydrogen storage tank that is provided with an outlet pipe, assisted by a solenoid valve and/or shut-off valve, a non-return valve and a flow/pressure regulator.

### OBJECT OF THE INVENTION

The present invention refers to a device that has been specially designed in order to allow the generation of hydrogen from water, ferrosilicon, sodium hydroxide and compressed air.

The object of the invention is therefore to provide a cheap and efficient device for the generation of hydrogen.

### BACKGROUND OF THE INVENTION

Hydrogen is considered by many to be the fuel of the future, as it is an excellent alternative to fossil fuels, reducing CO2 emissions into the atmosphere, which are responsible for the greenhouse effect and consequently global warming.

Until today the most common way to obtain hydrogen is by water electrolysis, a process in which hydrogen and oxygen are obtained.

However, this process implies a significant electrical consumption that makes said process not economically interesting.

### DISCLOSURE OF THE INVENTION

The hydrogen generator that is recommended successfully solves the problem previously set out, based on a completely different solution that provides a novel, much more cost-effective and efficient system.

To this aim, and more specifically, the generator of the invention is constituted from a first pressurized tank into which water, ferrosilicon and sodium hydroxide are introduced.

Said tank is fed with pressurized air through a compressor, which discharges the pressurized air in the lower area of the tank, thus triggering the reaction between the different chemical components, and generating hydrogen.

The generated hydrogen exits through the upper area of the first tank in order to be introduced through the corresponding pipe in a cleaning tank, also pressurized, filled with water, so that the generated hydrogen is fed into the water tank through its lower area, thus crossing in an upward direction the volume of water, which collects the possible impurities that the hydrogen could have dragged, and exiting through the upper part of it.

Finally, the cleaning tank feeds through an upper duct into a hydrogen storage tank, in which the generated hydrogen is stored.

This tank is equipped with a pressure switch with normally closed contacts, a safety valve and an outlet conduit assisted by a solenoid valve.

Finally, it must be pointed out that the pipes that connect the tanks with each other will all include non-return valves in order to ensure the correct operation of the generator.

In this way, a much cheaper means of hydrogen generation is achieved than electrolysis processes, easily scaled according to the production requirements of each individual case.

### BRIEF DESCRIPTION OF THE DRAWINGS

In order to complement the description below and in order to help to a better understanding of the characteristics of the invention, according to a preferred example of its practical embodiment, a drawing is attached as an integral part of said description, in which the following has been represented, with illustrative and non-limiting purposes:

FIG. 1. Shows a schematic representation of the different components that form a hydrogen generator made according to the object of the present invention.

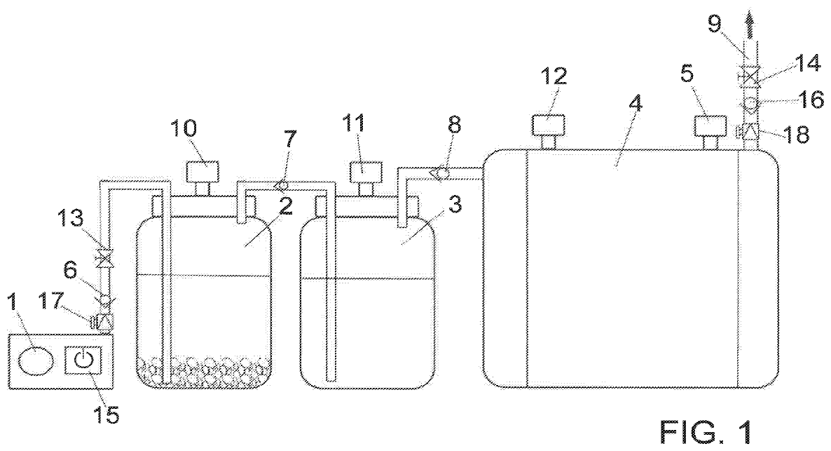

### PREFERRED EMBODIMENT OF THE INVENTION

In view of the referred FIGURE, it can be seen how the generator of the invention is involved in a pressurized tank acting as a reactor (2), into which water, ferrosilicon and sodium hydroxide are introduced, said tank being fed through its lower zone by means of air pressurized by a compressor (1), with its corresponding switch (15), via a duct assisted by an electrovalve and/or a shut-off valve (13), a non-return valve (6) and a flow/pressure regulator (17).

The pressurized tank acting as a reactor (2) will include a safety valve (10), as well as an upper outlet that communicates with a pipe in which a second non-return valve (7) is located, through which the hydrogen generated in the reactor flows, which undergoes a cleaning process before being stored.

To this aim, the aforementioned outlet pipe from the reactor feeds a pressurized washing tank (3), filled with water, also equipped with a safety valve (11), and into which hydrogen enters through its lower area, thus crossing in an upward direction the volume of water, which collects any possible impurities that the hydrogen could have dragged along, exiting through the upper area of the same through a pipe in which a third non-return valve (8) is located and which feeds a pressurized hydrogen storage tank (4), with its corresponding safety valve (12) and its pressure switch (5).

The pressure switch (5) controls that a pressure level is not exceeded, acting on the compressor (1).

Finally, in order to extract the hydrogen, the hydrogen storage tank (4) will have an outlet pipe (9), assisted by a solenoid valve and/or shut-off key (14), a non-return valve (16) and a flow/pressure regulator (18).

The device thus described is cost-effective and easy to develop, making it an alternative to existing hydrogen generation systems by electrolysis.

1. A hydrogen generator comprising a pressurized tank acting as a reactor, into which water, ferrosilicon and sodium hydroxide are introduced, said tank being fed through its lower area with pressurized air by means of a compressor, via a duct assisted by an electrovalve and/or a shut-off valve, a non-return valve and a flow/pressure regulator, said pressurized tank acting as a reactor that includes an upper outlet in communication with a pipeline in which a second non-return valve is located, and which feeds a pressurized washing tank through its lower area, filled with water, including a pipe in its upper area in which a third non-return valve is located and which feeds a pressurized hydrogen storage tank that has an outlet pipe, assisted by a solenoid valve and/or a shut-off valve, a non-return valve and a flow/pressure regulator.

2. The hydrogen generator of claim 1, wherein the pressurized tank which acts as a reactor includes a safety valve (10).

3. The hydrogen generator of claim 1, wherein the pressurized washing tank includes a safety valve.

4. The hydrogen generator of claim 1, wherein the pressurized hydrogen storage tank includes a safety valve and a pressure switch acting on the compressor once a preset pressure is exceeded.

5. The hydrogen generator of claim 1, wherein the compressor includes a switch.
